(19) United States
(12) Patent Application Publication
(10) Pub. No.: US 2023/0005132 A1
(43) Pub. Date: Jan. 5, 2023

(54) IMAGE INSPECTION DEVICE AND IMAGE INSPECTION METHOD

(71) Applicant: Mitsubishi Electric Corporation, Tokyo (JP)

(72) Inventors: Kohei OKAHARA, Tokyo (JP); Akira MINEZAWA, Tokyo (JP)

(73) Assignee: Mitsubishi Electric Corporation, Tokyo (JP)

(21) Appl. No.: 17/894,275

(22) Filed: Aug. 24, 2022

Related U.S. Application Data
(63) Continuation of application No. PCT/JP2020/017946, filed on Apr. 27, 2020.

(51) Int. Cl. G06T 7/00; G06T 7/33; G06T 5/50; G06V 10/24

(52) U.S. Cl. CPC G06T 7/0008; G06T 7/337; G06T 5/50; G06V 10/242; G06T 2207/20132; G06T 2207/20224; G06T 2207/30108

(57) ABSTRACT

An image inspection device includes: an image acquisition unit to acquire an inspection target image; a geometric transformation processing unit to estimate a geometric transformation parameter for aligning a position of an inspection target in the inspection target image with a first reference image in which a position of the inspection target is known, and geometrically transform the inspection target image using the estimated geometric transformation parameter, thereby generating an aligned image in which the position of the inspection target is aligned with the first reference image; an image restoration processing unit to restore the aligned image, using an image generation network to receive an input image generated using the inspection target image and infer the aligned image as a correct image; and an abnormality determination unit to determine an abnormality of the inspection target using a difference image between the aligned image and the restored aligned image.

### CROSS REFERENCE TO RELATED APPLICATIONS

This application is a Continuation of PCT International Application No. PCT/JP2020/017946 filed on Apr. 27, 2020, which is hereby expressly incorporated by reference into the present application.

### TECHNICAL FIELD

The present disclosure relates to an image inspection device and an image inspection method.

### BACKGROUND ART

A technique for determining an abnormality of an inspection target on the basis of a result of inspecting an image in which the inspection target is photographed has been proposed. For example, the image inspection method described in Non-Patent Literature 1 causes an auto encoder or a Generative Adversarial Network (GAN) to learn an image generation method for restoring a normal image on the basis of a feature extracted from the normal image in which a normal inspection target is photographed. This image generation method has a property that a normal image cannot be accurately restored by a feature extracted from an abnormal image in which an abnormal inspection target is photographed. The image inspection method described in Non-Patent Literature 1 calculates a difference image between an image in which an inspection target is photographed and a restored image, and determines an abnormality of the inspection target on the basis of the difference image.

### CITATION LIST

### Non-Patent Literature

Non-Patent Literature 1: Schlegl, Thomas, et al., “Unsupervised anomaly detection with generative adversarial networks to guide marker discovery”, ICIP 2017.

### SUMMARY OF INVENTION

### Technical Problem

When a part of the appearance of a product being the subject is an inspection target, a certain region in an image in which the product is photographed is an inspection target image region. In this case, between an image photographed in a state where the product directly faces the camera and an image photographed in a state where the product does not directly face the camera, a shift occurs in the position and posture of the inspection target in the image. The conventional technique described in Non-Patent Literature 1 has a problem that it can be seen that there is an abnormality in the inspection target due to occurrence of a shift in the position and posture, but it is not possible to accurately determine in which part of the inspection target the abnormality has occurred.

The present disclosure solves the above problems, and an object of the present disclosure is to obtain an image inspection device and an image inspection method capable of performing image inspection robust to changes in positions and postures of an inspection target and a photographing device.

### Solution to Problem

An image inspection device according to the present disclosure includes: image acquisition circuitry to acquire a first image in which an inspection target is photographed; geometric transformation processing circuitry to estimate a geometric transformation parameter used for aligning a position of the inspection target in the first image with a first reference image in which a position of the inspection target is known, and geometrically transform the first image by using the estimated geometric transformation parameter, thereby generating a second image in which the position of the inspection target in the first image is aligned with the first reference image; image restoration processing circuitry to restore the second image, by using an image generation network to receive an input of a third image generated by using the first image and infer the second image as a correct image; and abnormality determination circuitry to determine an abnormality of the inspection target, by using a difference image between the second image obtained by the geometric transformation on the first image and the restored second image.

### Advantageous Effects of Invention

According to the present disclosure, even when changes occur in positions and postures of an inspection target and a photographing device, the inspection target on a first image is aligned by geometric transformation using a first reference image in which the position of the inspection target is known. A second image is restored, by using an image generation network that infers, as a correct image, the second image in which the inspection target is aligned. The abnormality of the inspection target is determined, by using a difference image between the second image obtained by the geometric transformation on the first image and the restored second image. As a result, the image inspection device according to the present disclosure can perform image inspection robust to the changes in the positions and postures of the inspection target and the photographing device.

### BRIEF DESCRIPTION OF DRAWINGS

FIG. 1A is a schematic diagram illustrating an image photographed in a state where a subject directly faces a camera, and FIG. 1B is a schematic diagram illustrating an image photographed in a state where the subject does not directly face the camera.

FIG. 2 is a block diagram illustrating a configuration of an image inspection device according to a first embodiment.

FIG. 3 is a flowchart illustrating an image inspection method according to the first embodiment.

FIG. 4A is a block diagram illustrating a hardware configuration for implementing the functions of the image inspection device according to the first embodiment, and FIG. 4B is a block diagram illustrating a hardware configuration for executing software for implementing the functions of the image inspection device according to the first embodiment.

FIG. 5 is a block diagram illustrating a configuration of an image inspection device according to a second embodiment.

FIG. 6 is a flowchart illustrating an image inspection method according to the second embodiment.

### DESCRIPTION OF EMBODIMENTS

### First Embodiment

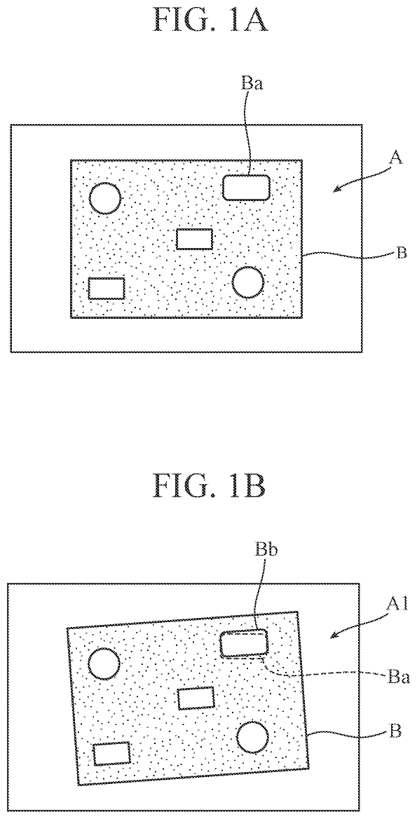

FIG. 1A is a schematic diagram illustrating an image A photographed in a state where a subject B directly faces a camera. FIG. 1B is a schematic diagram illustrating an image A1 photographed in a state where the subject B does not directly face the camera. When the subject B to be inspected is photographed in a state of directly facing the camera, for example, the image A in which the subject B is photographed is obtained as illustrated in FIG. 1A. In the image A, one component Ba of the subject B is photographed at a predetermined position.

In a case where a position and a posture of the subject B are shifted or a position and a posture of the camera are shifted, the subject B is photographed in a state of not directly facing the camera. For example, as illustrated in FIG. 1B, the subject B is obliquely photographed in the image A1, and the positional shift of a component Ba in the image A1 may be erroneously recognized as being photographed like a component Bb due to occurrence of abnormality in the component Ba. That is, this positional shift is a factor that the abnormality of the component Ba cannot be accurately determined.

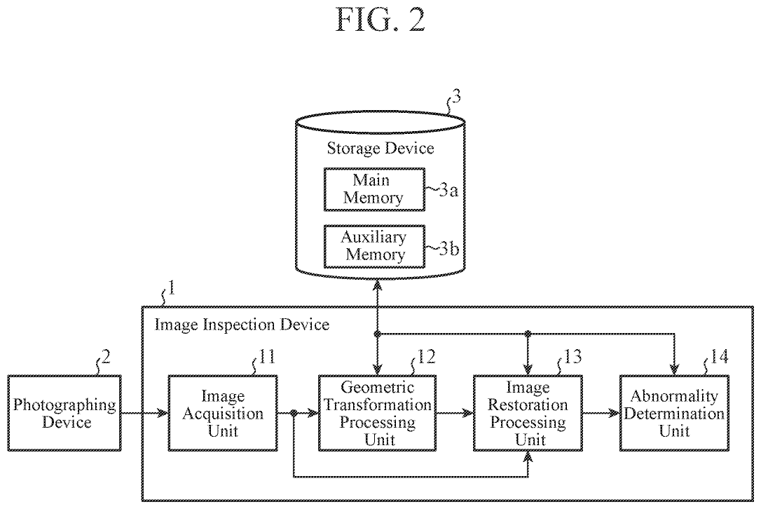

FIG. 2 is a block diagram illustrating a configuration of an image inspection device 1 according to a first embodiment. In FIG. 2, the image inspection device 1 is connected to a photographing device 2 and a storage device 3, receives an input of an image in which an inspection target is photographed by the photographing device 2, and determines an abnormality of the inspection target using the input image and data stored in the storage device 3.

The photographing device 2 is a camera that photographs an inspection target, and is, for example, a network camera, an analog camera, a USB camera, or an HD-SDI camera. The storage device 3 is a storage device that stores data used or generated in image inspection processing performed by the image inspection device 1, and includes a main memory 3a and an auxiliary memory 3b.

The auxiliary memory 3b stores a learned model that is an image generation network, parameter information such as model information defining a configuration of the learned model, a first reference image used for alignment of an inspection target, a second reference image used for creation of an image input to the image generation network, threshold information used for abnormality determination of the inspection target, and annotation information such as a position of the inspection target and a region of the inspection target in the image. The information stored in the auxiliary memory 3b is read into the main memory 3a and used by the image inspection device 1.

As illustrated in FIG. 2, the image inspection device 1 includes an image acquisition unit 11, a geometric transformation processing unit 12, an image restoration processing unit 13, and an abnormality determination unit 14. The image acquisition unit 11 acquires an image in which the inspection target is photographed by the photographing device 2 via an input interface (I/F). The image in which the inspection target is photographed by the photographing device 2 is a first image including not only an image in a state in which the subject as the inspection target directly faces a photographing field of view of the photographing device 2 but also an image in a state in which the subject does not directly face the photographing field of view of the photographing device 2.

The geometric transformation processing unit 12 estimates a geometric transformation parameter used for aligning the position of the inspection target in the image acquired by the image acquisition unit 11 with the first reference image in which the position of the inspection target is known. Then, the geometric transformation processing unit 12 uses the estimated geometric transformation parameter to geometrically transform the image acquired by the image acquisition unit 11, thereby generating an image in which the position of the inspection target is aligned with the first reference image.

The first reference image is an image in which the position of the inspection target is known, and is photographed in a state where the inspection target directly faces the photographing field of view of the photographing device 2. For example, when the component Ba illustrated in FIG. 1A is an inspection target, the image A in which the position of the component Ba is known can be used as the first reference image. The image generated by the geometric transformation processing unit 12 is a second image in which the position of the inspection target is aligned with the first reference image.

The image restoration processing unit 13 inputs an input image generated using the image acquired by the image acquisition unit 11 to the image generation network, thereby restoring an image in which the position of the inspection target is aligned with the first reference image from the input image. The input image to the image generation network is a third image generated using the inspection target image acquired by the image acquisition unit 11, and is, for example, a difference image between the inspection target image acquired by the image acquisition unit 11 and the second reference image in which the position of the inspection target is known.

The image generation network is a learned model that receives, as an input, the input image generated by the image restoration processing unit 13 and infers, as a correct image, an image in which the position of the inspection target is aligned with the first reference image. For example, the image generation network has learned image conversion between an input image and an output image by using, as learning data, a plurality of pairs of a correct image (output image) that is an image in which a normal inspection target generated by the geometric transformation processing is photographed and an input image that is an image related to the normal inspection target generated by the image restoration processing unit 13.

The abnormality determination unit 14 calculates a difference image between the inspection target image geometrically transformed by the geometric transformation processing unit 12 and the inspection target image restored by the image restoration processing unit 13, and determines an abnormality of the inspection target using the difference image. For example, the abnormality determination unit 14 specifies the inspection target in the difference image on the basis of the annotation information indicating the position of the inspection target and the region of the inspection target in the image, and determines the abnormality of the inspection target on the basis of a result of comparing a difference image region of the specified inspection target with the threshold information. The difference image is, for example, an amplitude image, a phase image, or an intensity image. The threshold information is a threshold of an amplitude, a phase, or an intensity.

An image inspection method according to the first embodiment is as follows.

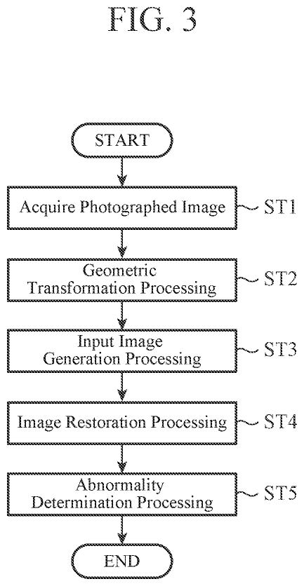

FIG. 3 is a flowchart illustrating the image inspection method according to the first embodiment, and illustrates a series of processes of the image inspection executed by the image inspection device 1.

The product to be inspected is disposed in the photographing field of view of the photographing device 2, and is photographed by the photographing device 2. An image of the inspection target photographed by the photographing device 2 is an “inspection target image”. The image acquisition unit 11 acquires inspection target images sequentially photographed by the photographing device 2 (step ST1). The inspection target image acquired by the image acquisition unit 11 is output to the geometric transformation processing unit 12.

The geometric transformation processing unit 12 estimates a geometric transformation parameter used for aligning the position of the inspection target in the inspection target image with the first reference image in which the position of the inspection target is known, and geometrically transforms the inspection target image using the geometric transformation parameter, thereby generating an image in which the position of the inspection target is aligned with the first reference image (step ST2). For example, the geometric transformation processing unit 12 estimates the geometric transformation parameter through image registration processing.

The image registration is processing of estimating a geometric transformation parameter between an attention image and a reference image, on the basis of the similarity between the feature points extracted from the attention image and the reference image or the similarity between the image regions image-converted between the attention image and the reference image. Examples of the geometric transformation processing include Euclidean transformation, affine transformation, and homography transformation that are linear transformations. Furthermore, the geometric transformation processing may be at least one of image rotation, image inversion, or cropping.

In the auxiliary memory 3b included in the storage device 3, an inspection target image photographed in a state where the inspection target directly faces the photographing field of view of the photographing device 2 is stored as a first reference image. Information indicating the position of the inspection target in the inspection target image and the image region of the inspection target in the inspection target image is annotated in the first reference image. For example, the image A illustrated in FIG. 1A is stored in the storage device 3 as a first reference image, and annotation information indicating the position of the component Ba and the image region of the component Ba is added to each of the first reference images.

The geometric transformation processing unit 12 executes image registration processing of aligning the position of the inspection target in the inspection target image photographed by the photographing device 2 with the position specified on the basis of the annotation information added to the first reference image, and estimates the geometric transformation parameter necessary for the alignment. Then, the geometric transformation processing unit 12 performs the geometric transformation processing using the geometric transformation parameter on the inspection target image photographed by the photographing device 2, thereby generating the image of the inspection target photographed in the same position and posture as the first reference image. Hereinafter, the image generated by the geometric transformation processing unit 12 is an “aligned image”.

The image restoration processing unit 13 generates an input image to the image generation network (step ST3). For example, when the image generation network is a neural network having a skip connection across a plurality of layers as in the U-net, learning is performed in such a way that the weight of the route to be skip-connected increases. Therefore, the image generation network learns to output the input image as it is, and it is difficult to extract the difference between the aligned image and the output image.

Therefore, the image restoration processing unit 13 inputs, as an input image, an image obtained by processing the inspection target image, to the image generation network. The image obtained by processing the inspection target image may be, for example, a difference image between the inspection target image and the second reference image. As for the second reference image, for example, an average image of a plurality of inspection target images each of in which a normal inspection target is photographed is used and stored in the auxiliary memory 3b. Note that, when the image generation network has no skip connection, the input image may be the aligned image.

The image restoration processing unit 13 restores the aligned image, by inputting the input image generated as described above to the image generation network (step ST4). For example, the image generation network receives an input of the difference image between the inspection target image and the second reference image, and infers (restores) the aligned image.

The abnormality determination unit 14 determines an abnormality of the inspection target, by using a difference image between the inspection target image geometrically transformed by the geometric transformation processing unit 12 and the aligned image restored by the image restoration processing unit 13 (step ST5). For example, when extracting the difference image between the geometrically transformed inspection target image and the restored aligned image, the abnormality determination unit 14 can specify of which inspection target a position and an image region the extracted difference image is on the basis of the annotation information added to the first reference image. The abnormality determination unit 14 determines that there is an abnormality in the inspection target of which the position and the image region have been specified.

As for a method of extracting the difference image, there is a method of using a sum or an average value of absolute differences of pixel values for each certain region (for example, for each component region in an image or for each pixel block of a certain size). In addition, as for a method of extracting a difference image, there is a method of using a structural similarity (SSIM or PSNR) of an image for each certain region. In a case where a pixel value of interest in the difference image is larger than the threshold, the abnormality determination unit 14 determines that there is an abnormality in the inspection target corresponding to the difference image region.

A hardware configuration for implementing the functions of the image inspection device 1 is as follows.

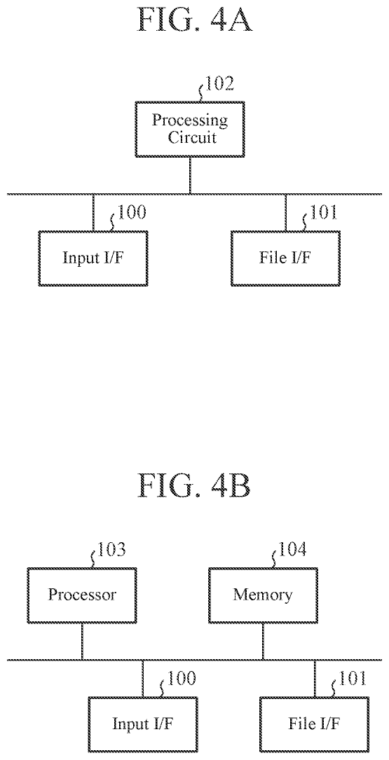

FIG. 4A is a block diagram illustrating a hardware configuration for implementing the functions of the image inspection device 1. FIG. 4B is a block diagram illustrating a hardware configuration for executing software for implementing the functions of the image inspection device 1. In FIGS. 4A and 4B, an input I/F 100 is an interface that receives an input of a video image photographed by the photographing device 2. A file I/F 101 is an interface that relays data exchanged with the storage device 3.

The functions of the image acquisition unit 11, the geometric transformation processing unit 12, the image restoration processing unit 13, and the abnormality determination unit 14 included in the image inspection device 1 are implemented by a processing circuit. That is, the image inspection device 1 includes a processing circuit for executing the processing of steps ST1 to ST5 illustrated in FIG. 3. The processing circuit may be dedicated hardware or a central processing unit (CPU) that executes a program stored in a memory.

In a case where the processing circuit is a processing circuit 102 of dedicated hardware illustrated in FIG. 4A, the processing circuit 102 corresponds to, for example, a single circuit, a composite circuit, a programmed processor, a parallel programmed processor, an application specific integrated circuit (ASIC), a field-programmable gate array (FPGA), or a combination thereof. The functions of the image acquisition unit 11, the geometric transformation processing unit 12, the image restoration processing unit 13, and the abnormality determination unit 14 included in the image inspection device 1 may be implemented by separate processing circuits, or these functions may be collectively implemented by one processing circuit.

In a case where the processing circuit is a processor 103 illustrated in FIG. 4B, the functions of the image acquisition unit 11, the geometric transformation processing unit 12, the image restoration processing unit 13, and the abnormality determination unit 14 included in the image inspection device 1 are implemented by software, firmware, or a combination of software and firmware. Note that, software or firmware is written as a program and stored in a memory 104.

The processor 103 reads and executes the program stored in the memory 104, thereby implementing the functions of the image acquisition unit 11, the geometric transformation processing unit 12, the image restoration processing unit 13, and the abnormality determination unit 14 included in the image inspection device 1. For example, the image inspection device 1 includes the memory 104 that stores programs that result in execution of the processing from step ST1 to step ST5 illustrated in FIG. 3 when executed by the processor 103. These programs cause a computer to execute procedures or methods performed by the image acquisition unit 11, the geometric transformation processing unit 12, the image restoration processing unit 13, and the abnormality determination unit 14. The memory 104 may be a computer-readable storage medium that stores a program for causing the computer to function as the image acquisition unit 11, the geometric transformation processing unit 12, the image restoration processing unit 13, and the abnormality determination unit 14.

Examples of the memory 104 correspond to a nonvolatile or volatile semiconductor memory, such as a random access memory (RAM), a read only memory (ROM), a flash memory, an erasable programmable read only memory (EPROM), or an electrically-EPROM (EEPROM), a magnetic disk, a flexible disk, an optical disk, a compact disk, a mini disk, and a DVD.

Some of the functions of the image acquisition unit 11, the geometric transformation processing unit 12, the image restoration processing unit 13, and the abnormality determination unit 14 included in the image inspection device 1 may be implemented by dedicated hardware, and the remaining may be implemented by software or firmware. For example, the function of the image acquisition unit 11 is implemented by the processing circuit 102 which is dedicated hardware, and the functions of the geometric transformation processing unit 12, the image restoration processing unit 13, and the abnormality determination unit 14 are implemented by the processor 103 reading and executing a program stored in the memory 104. Thus, the processing circuit can implement the above functions by hardware, software, firmware, or a combination thereof.

As described above, in the image inspection device 1 according to the first embodiment, even when changes occur in the positions and postures of the inspection target and the photographing device 2, the inspection target on the inspection target image is aligned by the geometric transformation using the first reference image in which the position of the inspection target is known. The aligned image is restored using an image generation network that infers, as a correct image, the aligned image in which the inspection target is aligned. The abnormality of the inspection target is determined using the difference image between the inspection target image aligned by the geometric transformation and the restored aligned image. As a result, the image inspection device 1 can perform image inspection robust to changes in the positions and postures of the inspection target and the photographing device.

### Second Embodiment

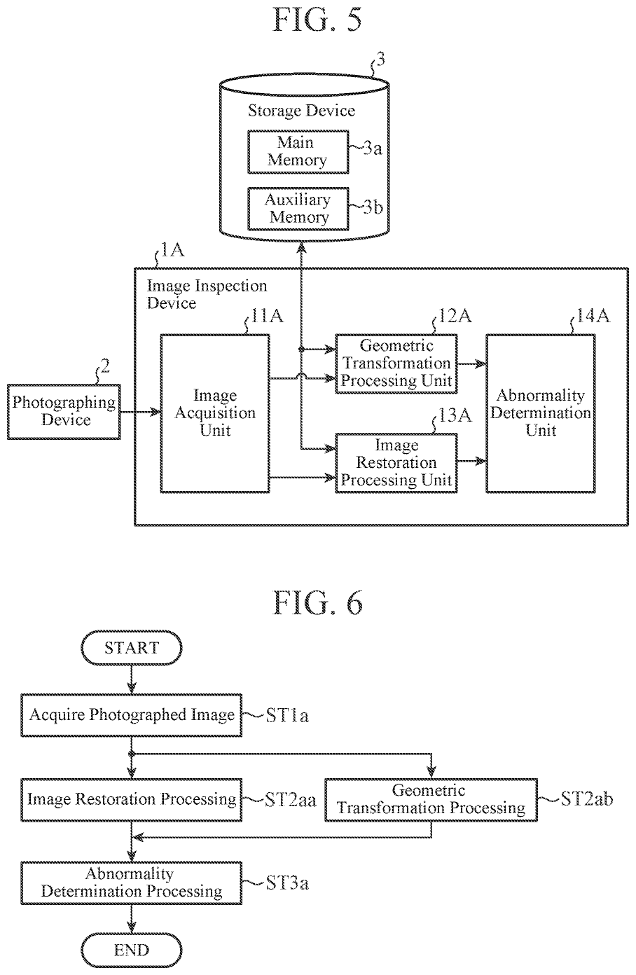

FIG. 5 is a block diagram illustrating a configuration of an image inspection device 1A according to a second embodiment. In FIG. 5, the image inspection device 1A is connected to the photographing device 2 and the storage device 3, receives an input of an image in which an inspection target is photographed by the photographing device 2, and determines an abnormality of the inspection target using the input image and data stored in the storage device 3. The image inspection device 1A includes an image acquisition unit 11A, a geometric transformation processing unit 12A, an image restoration processing unit 13A, and an abnormality determination unit 14A.

The image acquisition unit 11A acquires an inspection target image in which the inspection target is photographed by the photographing device 2 via the input I/F, and outputs the acquired image to the geometric transformation processing unit 12A and the image restoration processing unit 13A. The inspection target image acquired by the image acquisition unit 11A is a first image including not only an image in a state in which the subject as the inspection target directly faces a photographing field of view of the photographing device 2 but also an image in a state in which the subject does not directly face the photographing field of view of the photographing device 2.

The geometric transformation processing unit 12A estimates a geometric transformation parameter for aligning the position of the inspection target in the inspection target image acquired by the image acquisition unit 11A with the first reference image in which the position of the inspection target is known, and geometrically transforms the inspection target image by using the geometric transformation parameter, thereby generating an aligned image in which the position of the inspection target is aligned with the first reference image.

The image restoration processing unit 13A inputs the inspection target image (first image) acquired by the image acquisition unit 11A to the image generation network, thereby restoring the aligned image from the input image. The abnormality determination unit 14A calculates a difference image between the inspection target image geometrically transformed by the geometric transformation processing unit 12A and the aligned image restored by the image restoration processing unit 13A, and determines an abnormality of the inspection target using the difference image.

An image inspection method according to the second embodiment is as follows.

FIG. 6 is a flowchart illustrating the image inspection method according to the second embodiment, and illustrates a series of processes of image inspection executed by the image inspection device 1A. The image acquisition unit 11A acquires inspection target images sequentially photographed by the photographing device 2 (step ST1a). The inspection target image acquired by the image acquisition unit 11A is output to the geometric transformation processing unit 12A and the image restoration processing unit 13A.

The geometric transformation processing unit 12A estimates a geometric transformation parameter used for aligning the position of the inspection target in the inspection target image with the first reference image in which the position of the inspection target is known, and geometrically transforms the inspection target image by using the geometric transformation parameter, thereby generating an aligned image in which the position of the inspection target is aligned with the first reference image (step ST2ab). Note that, similarly to the geometric transformation processing unit 12 according to the first embodiment, the geometric transformation processing unit 12A estimates the geometric transformation parameter by, for example, image registration processing, and performs the geometric transformation processing using the geometric transformation parameter on the inspection target image acquired by the image acquisition unit 11A, thereby generating an aligned image.

In addition, the image restoration processing unit 13A restores the aligned image by directly inputting the inspection target image acquired by the image acquisition unit 11A to the image generation network (step ST2aa). For example, the image generation network has learned image conversion between an input image and an output image by using, as learning data, a plurality of pairs of a correct image (output image) that is an aligned image generated by the geometric transformation processing unit 12A and an input image that is an unaligned inspection target image acquired by the image acquisition unit 11A. Note that the image conversion of the learning target by the image generation network also includes geometric transformation of aligning the position of the inspection target in the unaligned inspection target image with the first reference image in which the position of the inspection target is known.

The abnormality determination unit 14A determines an abnormality of the inspection target, by using a difference image between the inspection target image geometrically transformed by the geometric transformation processing unit 12A and the aligned image restored by the image restoration processing unit 13A (step ST3 a). For example, when extracting the difference image between the geometrically transformed inspection target image and the restored aligned image, the abnormality determination unit 14A can specify of which inspection target a position and an image region the extracted difference image is on the basis of the annotation information added to the first reference image. The abnormality determination unit 14A determines that there is an abnormality in the inspection target of which the position and the image region have been specified.

Note that the functions of the image acquisition unit 11A, the geometric transformation processing unit 12A, the image restoration processing unit 13A, and the abnormality determination unit 14A included in the image inspection device 1A are implemented by a processing circuit. That is, the image inspection device 1A includes a processing circuit for executing the processing from step ST1a to step ST3a illustrated in FIG. 6. The processing circuit may be the processing circuit 102 of dedicated hardware illustrated in FIG. 4A, or may be the processor 103 that executes the program stored in the memory 104 illustrated in FIG. 4B.

As described above, in the image inspection device 1A according to the second embodiment, the input image to the image generation network is the inspection target image photographed by the photographing device 2. The image generation network receives an input of the inspection target image and infers the aligned image. The image restoration processing unit 13A restores the aligned image using the image generation network. As a result, the image inspection device 1A can perform image inspection robust to changes in the positions and postures of the inspection target and the photographing device. In addition, since the processing of generating the input image to the image generation network is omitted, the arithmetic processing amount is reduced as compared with the image inspection method according to the first embodiment. Furthermore, since the geometric transformation processing and the image restoration processing can be performed in parallel, the takt time of the image inspection can be shortened.

Note that combinations of the embodiments, modifications of any components of each of the embodiments, or omissions of any components in each of the embodiments are possible.

### INDUSTRIAL APPLICABILITY

The image inspection device according to the present disclosure can be used, for example, for abnormality inspection of a product.

### REFERENCE SIGNS LIST

1,1A: image inspection device, 2: photographing device, 3: storage device, 3a: main memory, 3b: auxiliary memory, 11,11A: image acquisition unit, 12,12A: geometric transformation processing unit, 13,13A: Image restoration processing unit, 14,14A: abnormality determination unit, 100: input I/F, 101: file I/F, 102: processing circuit, 103: processor, 104: memory

1. An image inspection device, comprising:
image acquisition circuitry to acquire a first image in which an inspection target is photographed;
geometric transformation processing circuitry to estimate a geometric transformation parameter used for aligning a position of the inspection target in the first image with a first reference image in which a position of the inspection target is known, and geometrically transform the first image by using the estimated geometric transformation parameter, thereby generating a second image in which the position of the inspection target in the first image is aligned with the first reference image;
image restoration processing circuitry to restore the second image, by using an image generation network to receive an input of a third image generated by using the first image and infer the second image as a correct image; and
abnormality determination circuitry to determine an abnormality of the inspection target, by using a difference image between the second image obtained by the geometric transformation on the first image and the restored second image.

2. The image inspection device according to claim 1, wherein
the third image is a difference image between the first image and a second reference image in which a position of the inspection target is known.

3. The image inspection device according to claim 1, wherein
the third image is the first image,
the image generation network receives an input of the first image and infers the second image, and
the image restoration processing circuitry restores the second image using the image generation network.

4. The image inspection device according to claim 1, wherein
the geometric transformation processing circuitry generates the second image, by geometrically transforming the first image through image registration on the first reference image.

5. The image inspection device according to claim 1, wherein
the geometric transformation processing circuitry generates the second image, by performing at least one of image rotation, image inversion, or cropping on the first image.

6. An image inspection method, comprising:
acquiring a first image in which an inspection target is photographed;
estimating a geometric transformation parameter used for aligning a position of the inspection target in the first image with a first reference image in which a position of the inspection target is known, and geometrically transforming the first image by using the estimated geometric transformation parameter, thereby generating a second image in which the position of the inspection target in the first image is aligned with the first reference image;
restoring the second image, by using an image generation network to receive an input of a third image generated by using the first image and infer the second image as a correct image; and
determining an abnormality of the inspection target, by using a difference image between the second image obtained by the geometric transformation on the first image and the restored second image.
